(19) United States
(12) Patent Application Publication
(10) Pub. No.: US 2008/0262874 A1
(43) Pub. Date: Oct. 23, 2008

(54) MEDICAL REPORT GENERATING SYSTEM AND A MEDICAL REPORT GENERATING METHOD

(75) Inventor: Akihiro TOSHIMITSU, Otawara-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignees: KABUSHIKI KAISHA TOSHIBA, Tokyo (JP); TOSHIBA MEDICAL SYSTEMS CORPORATION, Otawara-shi (JP)

(21) Appl. No.: 11/866,068

(22) Filed: Oct. 2, 2007

(30) Foreign Application Priority Data
Oct. 3, 2006 (JP) 2006-271490

(51) Int. Cl. G06Q 50/00

(52) U.S. Cl. 705/3; 707/1

(57) ABSTRACT

A device for generating a medical report by referencing contents that include at least a medical image, to which is attached information indicating attributes of the medical image, the device comprising a storage configured to store a processing for the contents associated with a keyword to be employed in said medical report and the attributes related to contents, wherein the device designates a range of a string descried in the medical report; designates all or a portion of the contents associated with the designated range of the string; by searching the storage part, specifies a processing that corresponds to the keyword indicated by the designated range of the string and the attributes of all or portion of the designated contents; and performs the specified processing on all or a portion of the contents.

### BACKGROUND OF THE INVENTION

1. Field of the Invention

The present invention relates to a medical report generating system and a medical report generating method, for example, for a medical specialist to generate a medical report and reference medical images, and relates to having a function for linking medical images to a medical report.

2. Description of the Related Art

The recent popularity of digital image diagnostic devices such as X-ray CT devices, MRI (Magnetic Resonance Imaging) devices, and CR (Computed Radiography) devices, has increased the production of diagnostic images (medical images).

In addition, specialized fields of medical practices are divided into smaller areas, so medical specialists are frequently asked for the interpretation of the abovementioned medical images. The medical specialist, upon receiving a request, displays an image subject to the interpretation, writes up the results of the interpretation in a medical report, and then passes the report to the client.

In addition, a device for electronically performing this generation of the medical report is put into practical use. This device compiles a medical image that is passed, for example, from a client requesting interpretation via network delivery, displays a report sheet on a screen, and inputs necessary items on the sheet. Images to be interpreted are then sequentially displayed, remarks of the images are written into a remark entry space in the sheet, and diagnostic results considering the examination purpose of the client requesting interpretation are written in the diagnostic entry space, based on the remarks made of the image. Regarding the image pointed out in the remarks, a reduced/enlarged image or a clipped image is generated and pasted on an image-attachment section, as necessary. Sheet data of the medical report that has been generated according to the above procedure will be passed to the client requesting interpretation, for example, via a network.

Meanwhile, it is pointed out that the relationship between the entry content of the remarks and the pasted image is sometimes unclear in conventional medical reports as described above. For example, when a plurality of images that resemble each other are pointed out to exist in a sentence of the remarks, a misconception of an image to be pointed out may arise. In addition, when displaying the pasted image on a report screen, the remark information may not be conveyed correctly, depending on the monitor resolution or the size of the screen. Moreover, for reference of not only an interpretation image but also a past medical report, historical information, tedious work such as reading each information file, editing the same, and then pasting the same in the report, is required in order to compare it with the interpretation image.

Therefore, for example, Japanese Patent Application Laid-Open Publication 2005-301453 discloses the following medical report generating system. In other words, this system links contents, which is related to the content thereof, such as a medical image, a past report, or historical information, to the entry content of the remarks (range of a string) described in a medical report, displays the fact that the string is linked, and allows the linked contents to be displayed by designating the string.

In addition, for example, Japanese Patent Application Laid-Open Publication 2003-296451 discloses the following medical report generating system. In other words, this system displays a medical image in which a portion that is the basis of the entry content of the remarks is emphasized in order to facilitate the reading of the medical report, as well as the linking of the contents.

As described above, the relationship between the described content of the remarks and a medical image is made clear by linking the described content of the remarks and the medical image. In addition, the remarks content of the report is facilitated to decipher by applying a process to the medical image.

However, in generating a medical report, designation of display position is necessary to link the contents. In addition, it is necessary to perform search for a past medical report or historical information, for comparison. Furthermore, when interpreting a requested medical image, image processing such as CAD (Computer Aided Diagnostic) may be needed. In other words, tedious work is required to generate a medical report.

In addition, the comparison with a past medical report or historical information, and the image processing such as CAD are often fixed depending on types of a site to be examined of the contents to be referenced, an X-ray CT device, an MRI device, or a CR device to be employed in the examination (examination types). Therefore, when a necessary comparison or processing has not been performed, there is a problem about the generated medical report.

### SUMMARY OF THE INVENTION

The purpose of the present invention is to steadily enable a processing in accordance with a site to be examined or an examination type of contents referenced when generating a medical report.

A first aspect of the present invention is a medical report generating system for generating a medical report by referencing contents that include at least a medical image, to which information indicating attributes of the medical image is attached. This medical report generating system comprises: a storage part configured to store a processing for the contents associated with a keyword to be employed in said medical report and attributes related to contents; an input part configured to designate a range of a string described in said medical report and to designate all or a portion of said contents associated with said designated range of the string; and a processing part configured to specify, by searching said storage part, a processing that corresponds to the keyword indicated by said designated range of the string and the attributes of all or a portion of said designated contents, and to perform said specified processing on all or a portion of said contents.

A second aspect of the present invention is a medical report generating system for generating a medical report by referencing contents that include at least a medical image, to which information indicating attributes of the medical image is attached, the medical report generating system comprising: a storage part configured to store a processing for the contents associated with a keyword to be employed in said medical report and attributes related to contents; a keyword extracting part configured to extract a range of a string that indicates said keyword from the string described in said medical report; and a processing part configured to specify, by searching said storage part, a processing that corresponds to the keyword extracted by said extracting part and the attributes of all or a portion of said designated contents, and to perform said specified processing on all or a portion of said contents.

The third aspect of the present invention is a medical report generating method for a device for generating a medical report by referencing contents that include at least a medical image, to which information indicating attributes of the medical image is attached, the device comprising a storage part configured to store a processing for the contents associated with a keyword to be employed in said medical report and the attributes related to contents, wherein the medical report generating method comprises: designating a range of a string described in said medical report, designating all or a portion of said contents associated with said designated range of the string, and specifying, by searching said storage part, a processing that corresponds to the keyword indicated by said designated range of the string and the attributes of all or a portion of said designated contents, and performing said specified processing on all or a portion of said contents.

The fourth aspect of the present invention is a medical report generating method for a device for generating a medical report by referencing contents that include at least a medical image, to which information indicating attributes of the medical image is attached, the device comprising a storage part configured to store a processing for the contents associated with a keyword to be employed in said medical report and the attributes related to contents, wherein the medical report generating method comprises: extracting a range of a string that indicates said keyword from the string described in said medical report; and specifying, by searching said storage part, a processing that corresponds to said extracted keyword and the attributes of all or a portion of said designated contents, and performing said specified processing on all or a portion of said contents.

### BRIEF DESCRIPTION OF THE DRAWINGS

FIG. 1 is a block diagram that represents an entire configuration of a medical report generating system in an embodiment.

FIG. 2 is a block diagram that shows a report generator in a medical report generating system of the first embodiment.

FIG. 3 shows an example of a configuration of a processing table.

FIG. 4 shows an example of information that is pasted in the hyperlink form.

FIG. 5 is a flowchart that shows the operations of the report generator in the first embodiment.

FIG. 6 is a block diagram that shows a report generator in a medical report generating system of the second embodiment.

FIG. 7 is a diagram that shows a semantic contrast table.

FIG. 8 is a flowchart that shows the operations of the report generator in the second embodiment.

FIG. 9 is a block diagram that shows a report generator in a medical report generating system of the third embodiment.

FIG. 10 is a block diagram of an extracting part.

FIG. 11 is a flowchart that shows the operations of the report generator in the third embodiment.

### DETAILED DESCRIPTION OF THE EMBODIMENTS

### First Embodiment

### System Configuration

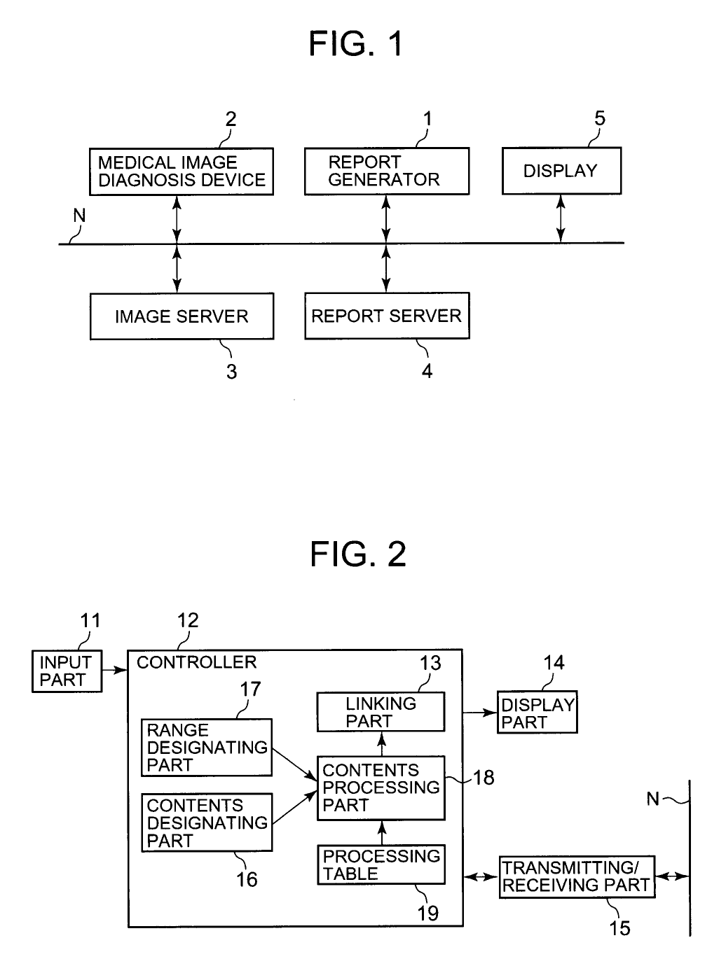

FIG. 1 shows a medical report generating system of the present embodiment. The medical report generating system of the present embodiment comprises a report generator 1 (medical management device), a medical image diagnosis device 2, an image server 3, a report server 4, and a display 5, which are each connected together via a network N such as a private communication line or the internet. In addition, a HIS (hospital information system) and a RIS (Radiology Information System) (not shown) are connected to the medical report generating system of the present embodiment.

The report generator 1 is a computer terminal comprising an application software. The report generator functions as an interpretation client. This interpretation client function includes a report generating function for displaying a predetermined report sheet and for inputting necessary items on the sheet, a medical image to be transmitted via the network N, a display of contents such as a past report, historical information, or the like. In accordance with the operation by a physician or an operator, the report generator 1 performs writing of remarks, a predetermined processing of contents, and writing of diagnostic results, thereby producing medical report data that indicate a medical report. In addition, the generator transmits this produced medical report data to the report server 4 via the network N.

The medical image diagnosis device 2 obtains medical image data by performing an examination, and transmits the medical image data to the image server 3 via the network N. In addition, the medical image diagnosis device 2 is, specifically, a so-called modality such as an ultrasonic diagnosis device, an X-ray CT device, a magnetic resonance imaging device (so-called MRI), a CR (Computed Radiography) device, or a nuclear medicine diagnosis device.

Moreover, FIG. 1 shows one medical image diagnosis device 2 in the present system, but a plurality of medical image diagnosis devices 2 are connected.

The image server 3 is a so-called server, which receives and stores the medical image data transmitted from the medical image diagnosis device 2, and transmits the medical image data to the report generator 1 or the display 5 depending on the request to transmit.

In addition, the report server 4 is a so-called server, which receives and stores the medical report data or history information transmitted from the report generator 1, and transmits the medical report data or historical information to the display 5 depending on the request to transmit.

Moreover, the image server 3 and the report server 4 may be a server that comprises a storage device housing a plurality of storage media such as a DVD (Digital Video Disc) and a CD (Compact Disk) and performing writing and reading by employing an auto-changer mechanism to automatically select a storage medium. Alternatively, they may be a server that comprises a high-capacity storage device (such as a hard disk).

The display 5 is a so-called computer terminal that comprises an application software, and which makes a request for transmission to the image server 3 or the report server 4 via the network N, and has a function as a so-called viewer for displaying an image based on the transmitted medical image data or for displaying a medical report based on the transmitted medical report data.

### Functional Configuration of the Report Generator

FIG. 2 is a block diagram that shows the report generator 1 in the medical report generating system of the present embodiment.

As shown in FIG. 2, the report generator 1 of the present invention comprises an input part 11, a controller 12, a display part 14, and a transmitting/receiving part 15. This report generator 1 generates a medical image by referencing contents. The contents include at least a medical image, to which information indicating attributes of this medical image is attached.

The input part 11 consists of an input device, such as a keyboard, for performing various inputs, or a pointing device such as a mouse and a trackball. This input part 11 designates a range of a string described in a medical report and designates all or a portion of the contents by associating with the designated range of the string.

In addition, the display part 14 displays an image or a report, and consists of a LCD or a CRT.

The transmitting/receiving part 15 consists of a transmission/receipt interface circuit, and executes the processing for transmitting/receiving various instructions, various requests, and various data, via the network N.

The controller 12 includes an arithmetic and control unit such as a CPU (Central Processing Unit) and includes a program storing part, such as a ROM (Read-Only Memory), for storing programs, and the controller 12 controls each part of the report generator 1 in accordance with the stored programs, various requests externally transmitted via the network, or instruction information input from the input part 11. In addition, the controller comprises a storage device that consists of a system memory composing a work area in execution of the program, or of a non-volatile RAM (Random Access Memory).

In addition, the controller 12 comprises a range-designating part 17, a contents-designating part 16, a contents-processing part 18, a processing table 19, and a linking part 13. The controller 12 has a function to generate a medical report based on an input from the input part 11, a display-control function to send instructions to display an image, a medical report, or the like, on the display part 14, and a function to transmit medical report data that indicates the generated medical report via the transmitting/receiving part 15.

The range-designating part 17 accepts an input for designating a range to a string. This string is in accordance with the input from the input part 11, and is described in the medical report during the generating process that is displayed on the display part 14. This range of the string will be input, for example, by pointing the cursor to the string via the input part 11, and by specifying the range. Informatively, a range of a string is a word or a phrase related to, for example, a site, remarks, or a diagnosis, and indicates a keyword to be employed in a medical report.

The contents-designating part 16 designates all or a portion of the contents by associating them with the designated range of the string. This designation of contents is performed, for example, by selectively displaying, on the display part 14, a file that indicates contents, by pointing the cursor to the desired contents by means of the input part 11, and by dragging and dropping the same into the designated range of the string.

The contents-processing part 18 performs a predetermined processing to the designated contents. The predetermined processing is stored in the processing table 19 with being associated with a keyword and attributes. The contents-processing part 18 executes a processing corresponding to the keyword and the attributes. Herein, the attributes include a site to be examined or an examination type, and are incidental to the contents as incidental information. The contents-processing part 18 obtains attribute information regarding the contents from the incidental information. For example, when the contents are an image, header information is incidental based on the DICOM format, and it includes attribute information such as an examination type, for example, CT or CR, and a site to be examined. Alternatively, after storing attributes and contents in advance in the form of a database in which they are associated with each other, the contents-processing part 18 may obtain attribute information by searching the database.

Thus, the processing table 19 associates the processing of the contents with the keyword to be employed in said medical report and the attributes related to the contents. Meanwhile, the contents-processing part 18 specifies, by searching said storage means, a processing that corresponds to the keyword indicated in the designated range of the string and attributes of all or a portion of the designated contents, and performs the specified processing on all or a portion of the contents.

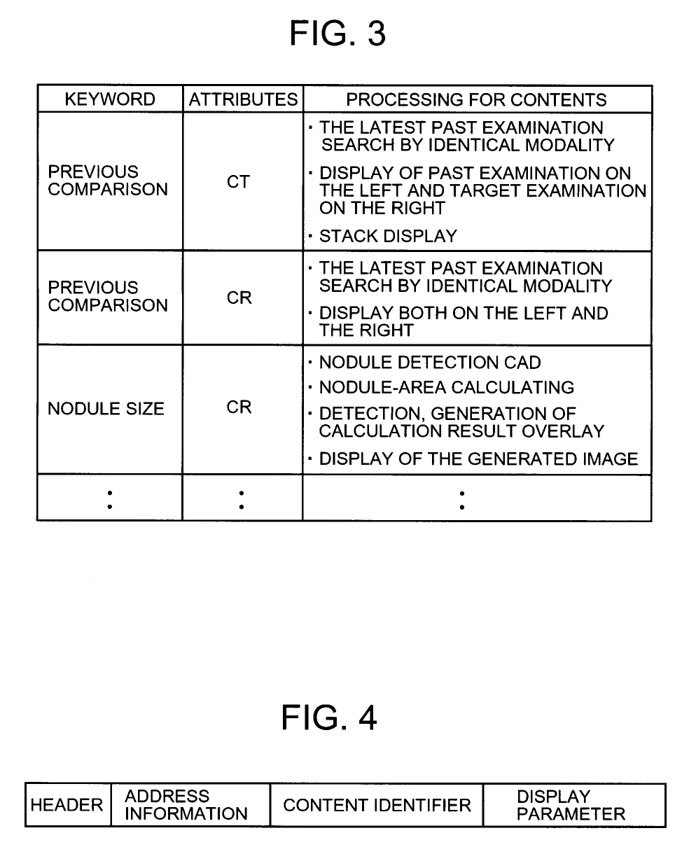

FIG. 3 shows an example of a configuration of the processing table 19. As shown in FIG. 3, a keyword, attributes, a processing for the contents are associated together per data and stored in the processing table 19. For example, when the “previous comparison” is designated as a range of a string and an attribute of image data as the designated contents is “CT,” the contents-processing part 18 obtains “the latest past examination search by identical modality, display of past examination on the left and target examination on the right, stack display” as a processing for the contents by retrieving data of which the keyword is the “previous comparison” and the attribute is “CT.” The contents-processing part 18 then makes a request for transmission of the nearest image data that has been obtained by the identical modality of the patient, that is, the medical image diagnosis device 2, to the image server 3. Upon receiving the image data, the display part 14 displays an image according to the nearest image data on the left and an image of the designated image data on the right in stack display format.

In addition, when the keyword is “nodule size” and the attribute is “CR,” the processing for the contents is “nodule detection CAD, nodule-area calculating, detection, generation of calculation result overlay, display of the generated image.” In other words, the contents-processing part 18 performs a CAD processing on an image that is based on the image data as the designated contents, calculates a nodule area from the processed image, produces an overlay, and displays the image. The contents-processing part 18 performs the processing in this way, and, when a new image is produced, the contents-processing part 18 transmits image data thereof to the image server 3 via the transmitting/receiving part 15, and the image server 3 saves the image data. In addition, not only the new image data, but also the contents such as historical information are saved in a similar way.

The linking part 13 links contents related to the designated range of the string with the designated range of the string. The associated contents are contents that have been obtained by the processing of the contents-processing part 18 or contents that have been produced by the processing. The contents obtained by the processing are, for example, contents that have been designated for the range of the string as described above, or contents that have been obtained by a search. In addition, the contents produced by the processing are, for example, contents that have been fabricated or produced, by a processing, such as the CAD-processed image or the image displaying the overlay described above. The linking is to obtain address information of the server in which the contents are saved, and to paste the address information to the string in the form of a hyperlink, along with the identifier of the contents (identification information). FIG. 4 shows an example of information that is pasted in the form of a hyperlink. As shown in FIG. 4, a header, address information, and a content identifier are included, and FIG. 4 is an example of contents that are an image and includes a display parameter such as a window level and window width to be applied position when displaying.

In addition, the controller 12 identifiably displays the fact that the linking is made, by changing the color of the range of the string to which a hyperlink is set and by underlining.

The controller 12 then transmits, as medical report data, the medical report generated as described above to the report server 4 via the transmitting/receiving part 15 and the network N and saves the same. In addition, the display 5 makes a request, to the report server 4, to transmit the medical report data, and displays a medical report based on the transmitted medical report data. Contents such as an associated image will be displayed by clicking the range of the string that is color-changed and underlined.

### Flowchart

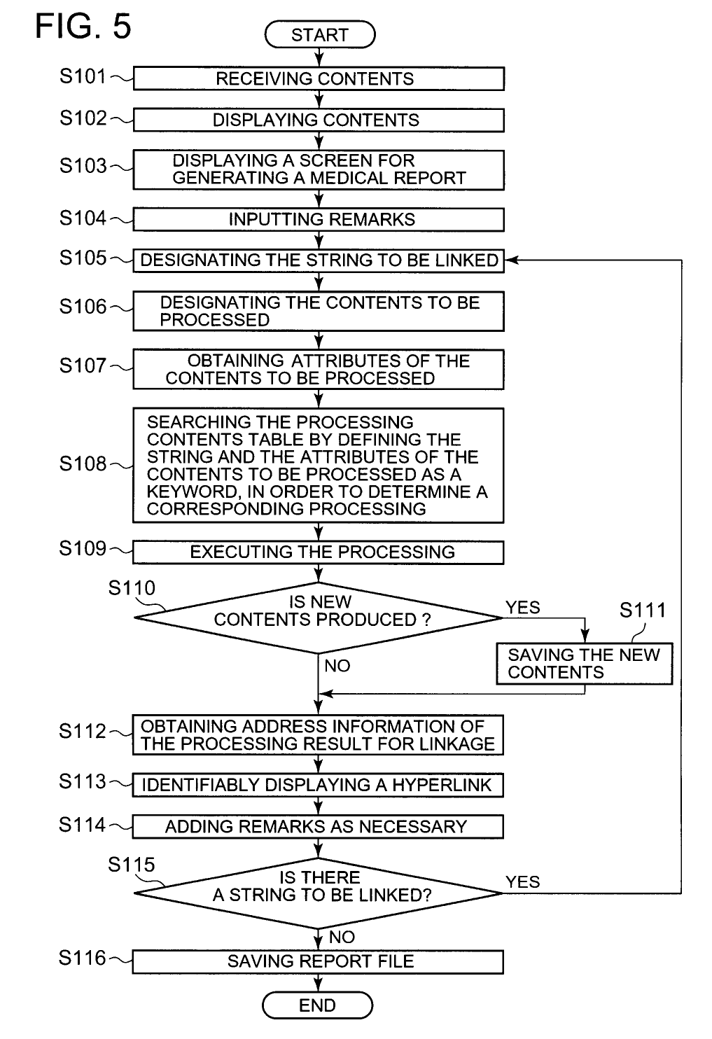

FIG. 5 is a flowchart that shows the operations of the report generator 1. An example of the processing of the report generator 1 of the present embodiment is explained with reference to FIG. 5.

First, the report generator 1 receives the contents, for example, via the network N (S101), and the controller 12 displays the contents on the display part 14 (S102). For example, the contents are transmitted depending on a request to transmit from the present report generator 1 or a request to transmit from another device to the report generator 1. For example, medical image data is transmitted from the image server 3 via the network N, and the controller 12 displays a medical image on the display part 14 upon receiving the medical image data.

Next, the controller 12 activates an application software for generating a medical report in accordance with instructions from the input part 11 and displays a screen for generating a medical report (S103). A remark entry space and a diagnostic entry space are displayed on this screen. When an operator inputs, for example, remarks on a medical image, the input string will be arranged in the remark entry space (S104). In order to link contents such as an image, a past medical report, or historical information with the string arranged in this way, the operator firstly performs an input operation for designating a range by pointing the cursor to the string via the input part 11. The range-designating part 17 of the controller 12 receives the input of range designation of the string (S105). Next, the operator designates, via the input part 11, the contents to be processed among contents displayed on the display part 14. The contents-designating part 16 of the controller 12 receives the input of contents designation (S106). For example, the operator designates the contents to be processed by dragging the contents and dropping the same into a portion of the designated range of the string that is displayed on the screen for generating a medical report, by means of the input part 11.

The contents-processing part 18 of the controller 12 obtains attributes of the designated contents from incidental information of the contents, for example (S107). Furthermore, the contents-processing part 18 searches the processing table 19, defines the designated range of the string as a keyword, determines a processing that corresponds to the keyword and the attributes of the contents (S108), and executes the processing (S109). At this time, when new contents have been produced as in the explanation of FIG. 3 (S110, YES), the controller 12 transmits the contents to a predetermined storage part such as the image server 3 and saves them (S111).

The linking part 13 of the controller 12 links contents obtained or produced by the processing to the designated range of the string in the form of a hyperlink (S112). The controller 12 identifiably displays the range of the string to which the hyperlink is set (S113). In addition, when there is an additional remark to be input, the operator inputs the same (S114).

Herein, when the operator further judges that there is a range of a string to be linked (S115, YES), S105 through S115 are repeated. Alternatively, when the operator judges that there is no range of a string to be linked (S115, NO), a “save and end” will be input, for example, via the input part 11. Herein, the controller 12 transmits the medical report data to the report server 4 via the transmitting/receiving part 15 and the network N and saves the same (S116). Thus, by performing on the designated contents a processing that corresponds to a keyword and attributes of the contents, it is possible to generate a medical report to which the processing result is linked. In addition, a processing for the contents is stored in the processing table 19 in advance, so it is possible to easily perform the processing that corresponds to the keyword and the attributes of the contents.

### Second Embodiment

A medical report generating system as the second embodiment according to the present invention is explained. Incidentally, a detailed explanation of a configuration that is substantively similar to the first embodiment is omitted, and different points are described below.

According to the present embodiment, when a range of a designated string has the identical meaning as a keyword in the processing table 19, the designated string can be enabled to be interpreted as the keyword. Thus, it is intended to execute a predetermined processing even when the range of the string does not completely conform to the keyword.

### Control Configuration of the Report Generator

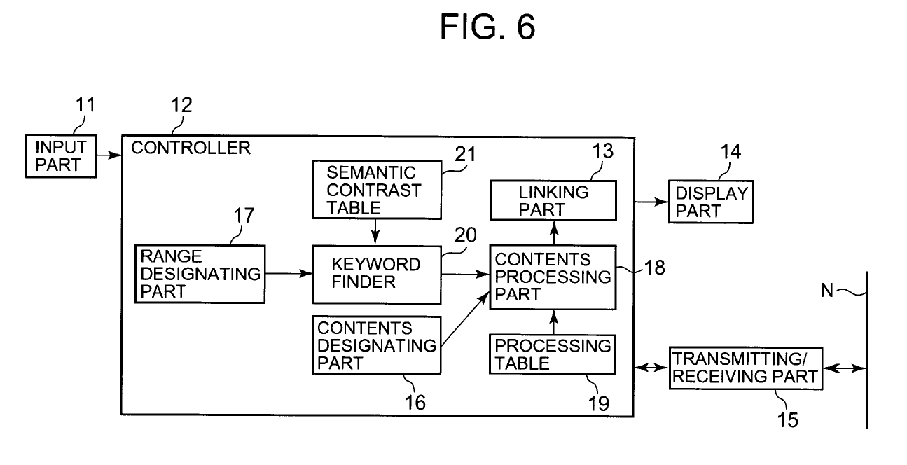

FIG. 6 is a block diagram that shows a report generator 1 in a medical report generating system of the present embodiment. As shown in FIG. 6, in the present embodiment, the controller 12 further comprises a keyword finder 20 and a semantic contrast table 21. The keyword finder 20 has a function of searching the semantic contrast table 21 and finding a keyword corresponding to the meaning of the range of the string that has been accepted by the range-designating part 17, and sends the found keyword to the contents-processing part 18.

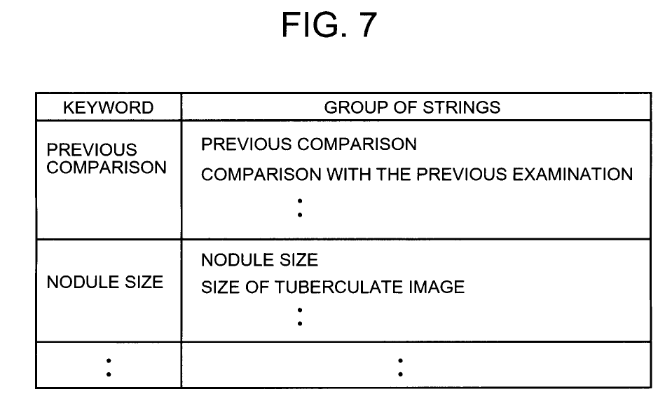

FIG. 7 shows an example of a configuration of the semantic contrast table 21. As shown in FIG. 7, a group of strings is associated with each keyword and stored in the semantic contrast table 21. In other words, the semantic contrast table 21 stores association information between a keyword and at least one string. In this regard, however, one string may be associated with a keyword, but it is desirable that there is a large number of groups of strings. First, the keyword finder 20 retrieves a keyword or a group of strings that conforms to the designated range of the string. When the search result conforms to a keyword, the keyword finder 20 sends the keyword to the contents-processing part 18. Otherwise, when it conforms to a string in the group of strings, the keyword finder 20 sends a keyword corresponding to the string to the contents-processing part 18. For example, when the designated range of the string is “previous comparison,” it conforms to the keyword “previous comparison,” so the “previous comparison” is transmitted to the contents-processing part 18 as a keyword. Alternatively, when the designated range of the string is “by comparing with the previous examination,” it conforms to the “by comparing with the previous examination” in the group of strings, so the “previous comparison” that corresponds to “by comparing with the previous examination” in the group of strings is transmitted to the contents-processing part 18 as a keyword. Thus, the keyword finder 20 specifies a keyword that is made to correspond to the designated range of the string by searching the association information. The specified keyword will be utilized in the contents-processing part 18. The contents-processing part 18 specifies a processing based on the sent keyword and performs the processing of the contents.

### Flowchart

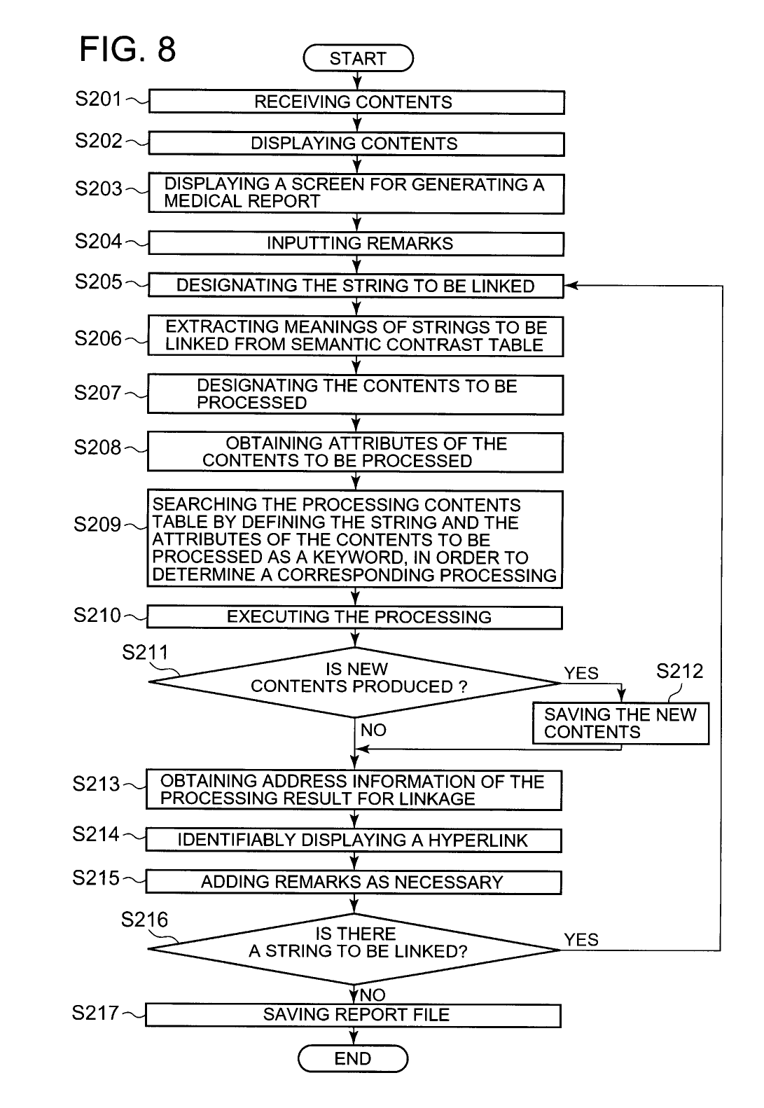

FIG. 8 is a flowchart that shows the operation of the report generator 1. An example of the processing procedures that are performed in the report generator 1 of the system in the present embodiment is explained by means of FIG. 8.

S201 through S205 shown in FIG. 8 are similar to S101 through S105 shown in FIG. 5 in the first embodiment, respectively. Next, at S206, the keyword finder 20 searches the semantic contrast table 21 for the accepted range of the string. The keyword finder 20 sends, when the string conforms to a keyword, the keyword, or when the string conforms to a group of strings, a keyword corresponding to the group of strings, to the contents-processing part 18.

Next, the operator performs an input operation for designating contents to be processed, as is the case with the first embodiment. The contents-designating part 16 of the controller 12 receives the input of contents designation (S207), and the contents-processing part 18 of the controller 12 obtains attributes of the designated contents (S208). Herein, the contents-processing part 18 searches the processing table 19, determines a processing that corresponds to the keyword sent from the keyword finder 20 and the attributes of the contents (S209), and executes the processing (S210).

Furthermore, S211 through S217 shown in FIG. 8 are similar to S110 through S116 shown in FIG. 5 in the first embodiment, respectively.

### Third Embodiment

A medical report generating system is explained as the third embodiment according to the present invention. Incidentally, a duplicate explanation of the first and second embodiments is omitted, and the different points are mainly described below.

The present embodiment intends to extract a keyword from the described string based on the input from the input part 11 in the medical report in the process of generation that is displayed on the display part 14, to find a content of a processing based on the extracted keyword, and to execute a predetermined processing.

### Control Configuration of the Report Generator

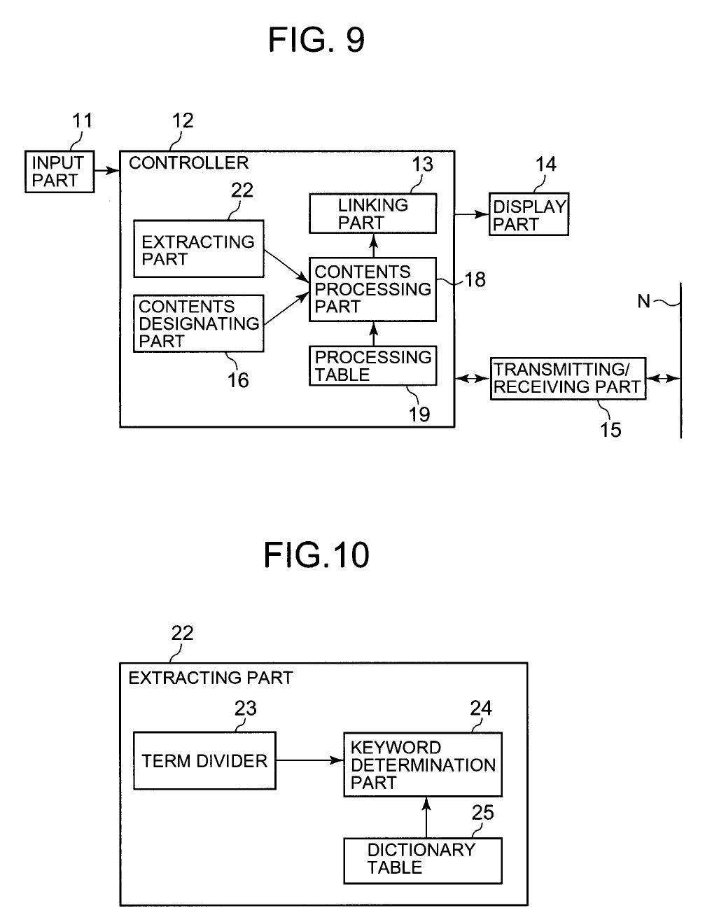

FIG. 9 is a block diagram that shows a report generator 1 in a medical report generating system of the present embodiment. As shown in FIG. 9, in the present embodiment, the controller 12 comprises an extracting part 22, instead of the range-designating part 17 in the first embodiment, or instead of the range-designating part 17, the keyword finder 20, and the semantic contrast table 21 in the second embodiment.

The extracting part 22 has a function for extracting a keyword from the string that is described, based on the input from the input part 11, in the medical report in process of generation that is displayed on the display portion 14, by utilizing a so-called text-mining technology (cf. Hiromasa YAMAGISHI et al. “Structurizing Interpretation of Radiographic Reports to the Unit of Description by Text-Mining Technology,” Journal of Japanese Society of Medical Imaging Technology (JAMIT), MEDICAL IMAGING TECHNOLOGY Vol. 23 No. 5 Nov. 2005, Page 328-332). Specifically, as shown in FIG. 10, a term divider 23, a keyword determination part 24, and a dictionary table 25 are included.

The term divider 23 divides text data of the string described in the medical report into each term by performing a morphological analysis. The dictionary table 25 stores in advance keywords such as a site term that indicates a site and a remark term that indicates a remark, and the keyword determination part 24 collates the divided terms in the dictionary table 25 and extracts a term as a keyword from the divided terms.

The contents-designating part 16 receives an input for designating contents to be processed. The input of this designation of contents is performed, for example, by selectively displaying, on the display part 14, a file that indicates the contents, pointing the cursor to the desired contents by means of the input part 11, and dragging and dropping the same into, for example, the remark space.

The contents-processing part 18 specifies a processing for the contents, based on the extracted keyword and the attributes of the contents to be processed. In other words, it specifies a processing that corresponds to the attributes of all or a portion of the designated contents. The contents-processing part then performs the specified processing on all or a portion of the contents.

### Flowchart

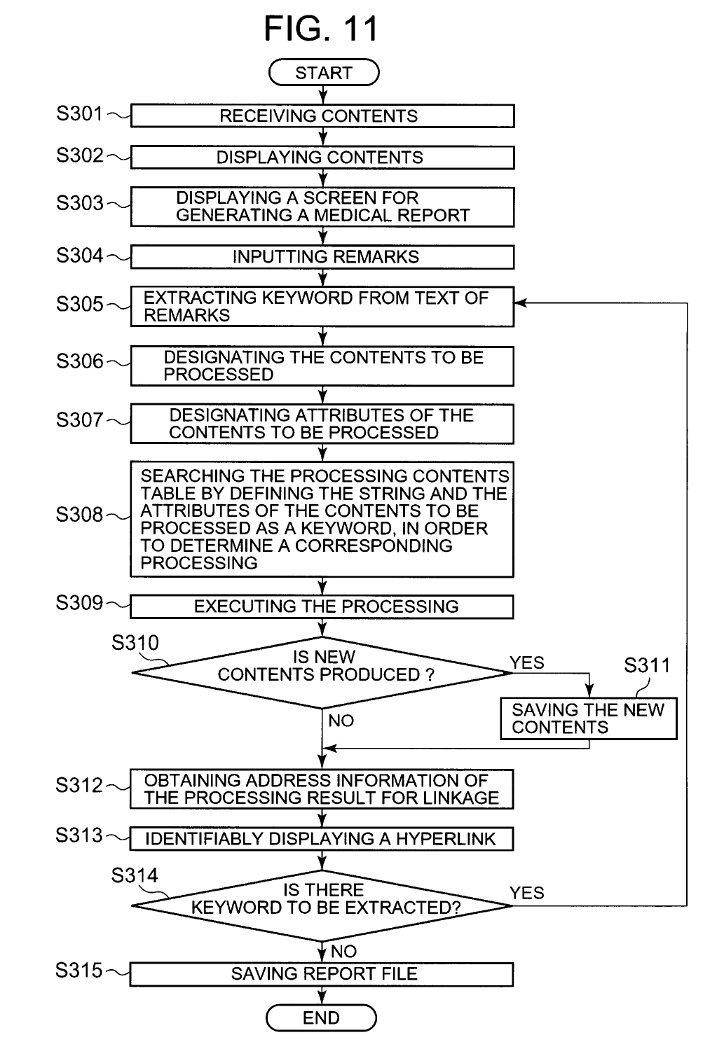

An example of the steps taken in a processing that is performed in the report generator 1 of the system in the present embodiment is explained by means of FIG. 11. FIG. 11 is a flowchart that shows the operations of the report generator 1.

S301 though S304 shown in FIG. 11 are similar to S101 through S104 shown in FIG. 5 in the first embodiment, respectively. When a remark is inputted, following a keyword-extraction instruction via the input part 11, for example, the extracting part 22 extracts a keyword by employing the text data of the string that is described in the remark space, as described above (S305).

Next, the operator performs an input for designating the contents to be processed among contents displayed on the display part 14 by employing the input part 11. The contents-designating part 16 of the controller 12 receives the input of contents designation (S306). For example, the operator designates the contents to be processed by dragging the contents and dropping the same into a portion of the remark space for generating a medical report, by means of the input part 11.

The contents-processing part 18 of the controller 12 obtains attributes of the designated contents, for example, from incidental information of the contents (S307). Furthermore, the contents-processing part 18 searches the processing table 19, determines a processing for the contents that corresponds to the extracted keyword and the attributes of the contents (S308), and executes the processing (S309). In this regard, however, when a plurality of keywords is extracted, the processing will be sequentially performed on each keyword. In addition, at this time, when new contents have been produced as in the explanation of FIG. 3 (S310, YES), the controller 12 transmits the contents to a predetermined storage part such as the image server 3 and saves them (S311).

The linking part 13 of the controller 12 links contents obtained or produced by the processing to the range of the string that is the keyword in the form of hyperlink (S312). The controller 12 identifiably displays the range of the string to which hyperlink is set (S313).

When another keyword has been extracted (S314, YES), S308 through S313 are repeated again. Alternatively, when another keyword has not been extracted (S314, NO), a save and the end will be inputted, for example, via the input part 11, and the controller 12 transmits the medical report data to the report server 4 via the transmitting/receiving part 15 and the network N and saves the same (S315).

According to the abovementioned medical report generating system and medical report generating method, it is possible to surely and easily perform a processing on contents to be referenced, by storing in advance a processing that corresponds to a keyword to be employed in a medical report and a site to be examined or an examination type of the contents to be referenced and by determining the processing from the keyword and the site to be examined or examination type of the contents to be referenced, when generating a medical report.

What is claimed is:

1. A medical report generating system for generating a medical report by referencing contents that include at least a medical image, to which information indicating attributes of the medical image is attached, said medical report generating system comprising:
a storage part configured to store a processing for the contents associated with a keyword to be employed in said medical report and attributes related to contents;
an input part configured to designate a range of a string described in said medical report and to designate all or a portion of said contents associated with said designated range of the string; and
a processing part configured to specify, by searching said storage part, a processing that corresponds to the keyword indicated by said designated range of the string and the attributes of all or a portion of said designated contents, and to perform said specified processing on all or a portion of said contents.

2. The medical report generating system according to claim 1, wherein
said storage part stores association information between a keyword and at least one string, and
said processing part specifies, by searching said association information, a keyword made to correspond to said designated range of the string, and employs the keyword.

3. The medical report generating system according to claim 1, further comprising:
a linking part configured to link contents obtained or produced by said processing to said designated range of the string.

4. A medical report generating system for generating a medical report by referencing contents that include at least a medical image, to which information indicating attributes of the medical image is attached, the medical report generating system comprising:
a storage part configured to store a processing for the contents associated with a keyword to be employed in said medical report and attributes related to contents;
a keyword extracting part configured to extract a range of a string that indicates said keyword from the string described in said medical report; and
a processing part configured to specify, by searching said storage part, a processing that corresponds to the keyword extracted by said extracting part and the attributes of all or a portion of said designated contents, and to perform said specified processing on all or a portion of said contents.

5. The medical report generating system according to claim 4, further comprising
a linking part configured to link contents obtained or produced by said processing to said extracted range of the string.

6. A medical report generating method for a device for generating a medical report by referencing contents that include at least a medical image, to which information indicating attributes of the medical image is attached, the device comprising a storage part configured to store a processing for the contents associated with a keyword to be employed in said medical report and the attributes related to contents, wherein the medical report generating method comprises:
designating a range of a string described in said medical report,
designating all or a portion of said contents associated with said designated range of the string, and
specifying, by searching said storage part, a processing that corresponds to the keyword indicated by said designated range of the string and the attributes of all or a portion of said designated contents, and performing said specified processing on all or a portion of said contents.

7. The medical report generating method according to claim 6, wherein
said storage part stores association information between a keyword and at least one string; and
said specifying the processing is performed by specifying, by searching said association information, a keyword corresponding to said designated range of the string, and specifying by employing the keyword.

8. The medical report generating method according to claim 6, further comprising:
displaying a screen used for generating said medical report; and
displaying all or a portion of said contents, wherein
said range designation is performed by designating said string that is displayed on said screen, and
said contents designation is performed by moving all or a portion of said contents onto said designated range of the string that is displayed on said screen.

9. The medical report generating method according to claim 6, further comprising:
linking contents obtained or produced by said processing to said designated range of the string.

10. A medical report generating method for a device for generating a medical report by referencing contents that include at least a medical image, to which information indicating attributes of the medical image is attached, the device comprising a storage part configured to store a processing for the contents associated with a keyword to be employed in said medical report and the attributes related to contents, wherein the medical report generating method comprises:
extracting a range of a string that indicates said keyword from the string described in said medical report; and
specifying, by searching said storage part, a processing that corresponds to said extracted keyword and the attributes of all or a portion of said designated contents, and performing said specified processing on all or a portion of said contents.

11. The medical report generating method according to claim 10, further comprising:
displaying a screen for generating said medical report, and
displaying all or a portion of said contents, wherein
said contents designation is performed by moving all or a portion of said contents onto the screen displayed on said screen.

12. The medical report generating method according to claim 6, further comprising:
linking contents obtained or produced by said processing to said extracted range of the string.

13. A medical report generating system, comprising:
an input part configured to input a string, a desired range of the inputted string, and contents to be associated with said designated string, for generating said medical report,
a storage part configured to store association information that indicates a relationship among a string to be employed in said medical report, attributes of contents, and a processing for the contents, and
a processing configured to execute a processing on said contents, based on the string that has been range-designated by said input part, contents that has been designation-inputted, and said association information that is stored on said storage part.

14. A medical report generating system, comprising:
an input part configured to input a string and contents, for generating said medical report,
a extracting part configured to extract a keyword from said inputted string,
a storage part configured to store association information that indicates a relationship among said keyword, attributes of contents, and a processing for the contents, and
a processing part configured to execute a processing on said contents, based on the keyword that has been extracted by said extracting part, the designation-inputted contents, and said association information that is stored on said storage part.
